(19) United States
(12) Patent Application Publication
(10) Pub. No.: US 2016/0001595 A1
(43) Pub. Date: Jan. 7, 2016

(54) VIBRATION DAMPENING ASSEMBLY FOR A WALK-BEHIND WORKING TOOL

(71) Applicant: MTD Products Inc, Valley City, OH (US)

(72) Inventors: Axel Schaedler, Olmsted Township, OH (US); Timothy Dilgard, Ashland, OH (US)

(21) Appl. No.: 14/751,782

(22) Filed: Jun. 26, 2015

Related U.S. Application Data
(60) Provisional application No. 62/019,568, filed on Jul. 1, 2014.

(51) Int. Cl. B60B 9/04; A01D 34/00; B60B 9/26; A01B 33/08

(52) U.S. Cl. CPC B60B 9/04; A01B 33/08; A01D 34/001; B60B 9/26; B60B 2900/313; B60B 2200/40

(57) ABSTRACT

A walk-behind working tool having a frame, a power source, and a handle attached to the frame is provided. The working tool includes at least one axle operatively connected to the frame and a pair of wheel assemblies connected to the axle. The wheel assemblies include a hub, a rim, a tire, and a flexible vibration dampening assembly that operatively connects the hub and rim, wherein the dampening assembly is configured to reduce the vibration transferred between the rim and hub and through the handle to the operator. The dampening assembly includes a plurality of elastic elements having a spring constant for smoothing out movement of the frame when the working tool is guided over rough or uneven ground.

### CROSS-REFERENCE TO RELATED APPLICATIONS

This application claims priority to U.S. Provisional Patent Application Ser. No. 62/019,568, filed Jul. 1, 2014.

### FIELD OF THE INVENTION

The present invention is directed to working tools, and more particularly, to walk-behind working tools used for lawn or property maintenance.

### BACKGROUND OF THE INVENTION

Walk-behind working tools such as walk-behind lawn mowers, tillers, snow throwers, and the like are operated over a variety of terrain. More particularly, the walk-behind lawn mowers are configured to cut grass, but the ground is not always flat or smooth. In addition, operators must guide the walk-behind mower over gravel driveways or rough surfaces in order to move the tool from one location to another. Similarly, tillers are typically guided over churned earth which makes for a very uneven surface. Also, snow throwers can be used on gravel driveways to clear snow, wherein the gravel provides a rough surface over which the snow thrower is guided. As these working tools are pushed or propelled over rough terrain, the working tool typically shakes and vibrates. This vibration radiates through the frame and the handle extending therefrom of the working tool. The vibration in the handle is transferred to the operator's hands and arms, which can lead to excessive shaking of the hands and arms.

### BRIEF SUMMARY OF THE INVENTION

In one aspect of the present invention, a walk-behind working tool is provided. The working tool includes a frame, a power supply attached to the frame, and a handle extending from the frame. The working tool also includes an axle operatively connected to the frame, wherein the axle is rotatable relative to the frame. At least one wheel assembly is operatively connected to each end of the axle. Each wheel assembly comprises a hub attachable to the axle, a rim, a tire attached to the rim, and a vibration dampening device extending between the rim and the hub.

In another aspect of the present invention, a walk-behind working tool is provided. The working tool includes a frame, a power supply attached to the frame, a handle extending from the frame, and an axle operatively connected to the frame, wherein the axle is rotatable relative to the frame. The working tool further includes a tire and a vibration dampening device operatively connecting the tire to the axle.

In yet another aspect of the present invention, a walk-behind working tool is provided. The working tool includes a frame, a power supply attached to the frame, an operator-graspable handle extending from the frame, and an axle operatively connected to the frame, wherein the axle is rotatable relative to the frame. The working tool further includes a pair of wheel assemblies rotatably connectable to the axle, wherein each of the wheel assemblies includes a vibration dampening device for reducing vibration transferred from the wheel assemblies to the handle by way of the frame.

Advantages of the present invention will become more apparent to those skilled in the art from the following description of the embodiments of the invention which have been shown and described by way of illustration. As will be realized, the invention is capable of other and different embodiments, and its details are capable of modification in various respects.

### BRIEF DESCRIPTION OF SEVERAL VIEWS OF THE DRAWINGS

These and other features of the present invention, and their advantages, are illustrated specifically in embodiments of the invention now to be described, by way of example, with reference to the accompanying diagrammatic drawings, in which:

FIG. 1A is a perspective view of an embodiment of a walk-behind working tool in the form of a walk-behind lawn mower;

FIG. 1B is a perspective view of an embodiment of a walk-behind working tool in the form of a walk-behind tiller;

FIG. 1C is a perspective view of an embodiment of a walk-behind working tool in the form of a walk-behind snow thrower;

FIG. 2A is a perspective view of an embodiment of a wheel assembly;

FIG. 2B is an opposite perspective view of the wheel assembly shown in FIG. 2A;

FIG. 3 is an exploded view of a portion of a walk-behind working tool, which includes an axle and a wheel assembly;

FIG. 4 is plan view of another embodiment of a wheel assembly;

FIG. 5A is an embodiment of a wheel assembly traversing flat ground;

FIG. 5B is the wheel assembly of FIG. 5A traversing uneven ground.

It should be noted that all the drawings are diagrammatic and not drawn to scale. Relative dimensions and proportions of parts of these figures have been shown exaggerated or reduced in size for the sake of clarity and convenience in the drawings. The same reference numbers are generally used to refer to corresponding or similar features in the different embodiments. Accordingly, the drawing(s) and description are to be regarded as illustrative in nature and not as restrictive.

### DETAILED DESCRIPTION OF THE PREFERRED EMBODIMENT

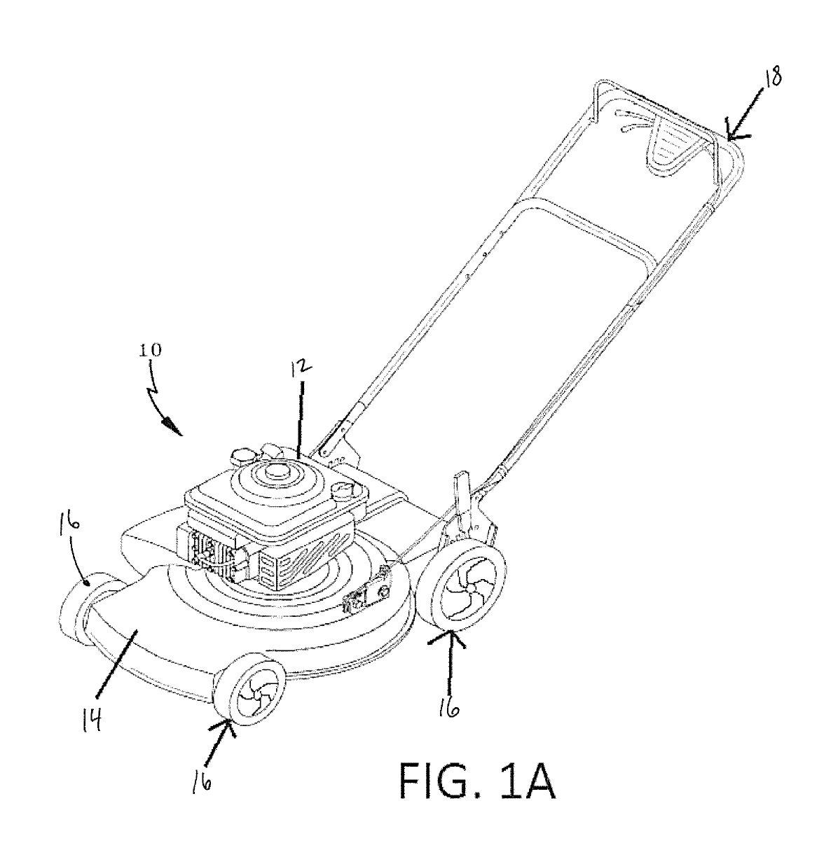

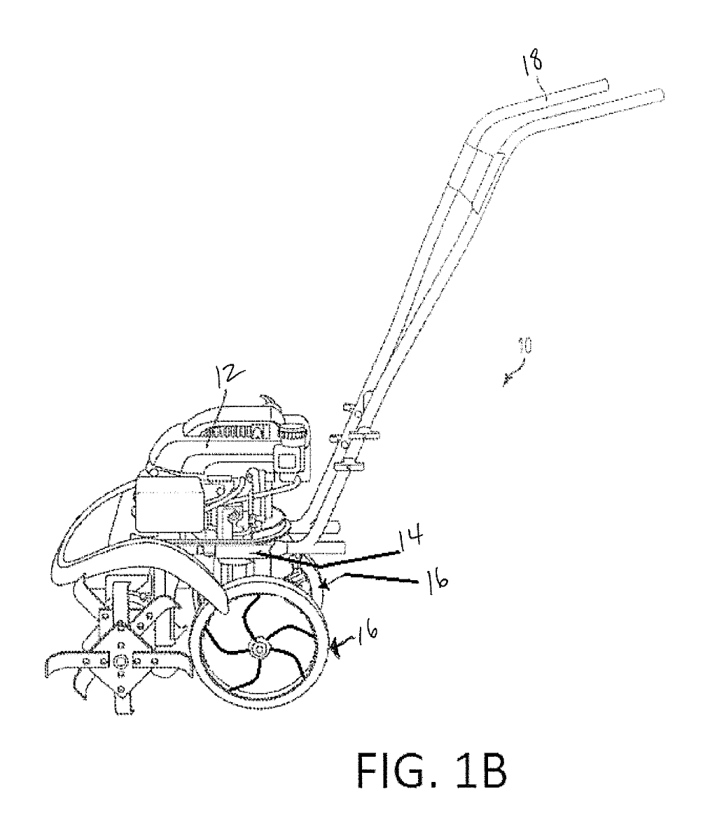

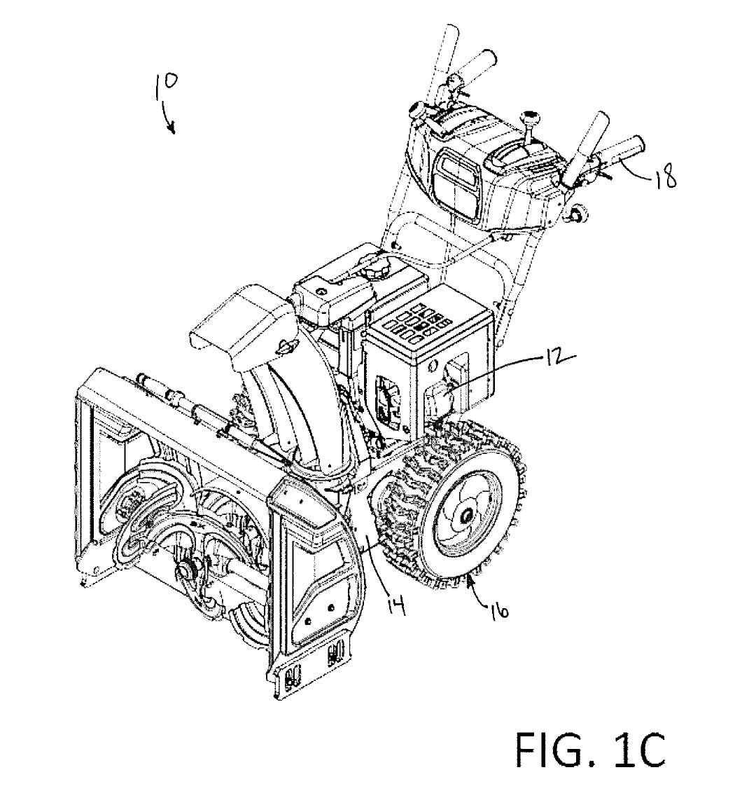

Referring to FIGS. 1A-1C, various embodiments of a walk-behind working tool 10 are shown. FIG. 1A illustrates a working tool 10 in the form of a walk-behind mower. FIG. 1B illustrates a working tool 10 in the form of a tiller. FIG. 1C illustrates a working tool 10 in the form of a snow thrower. In the figures, common elements are provided the same reference numerals for ease of reference. Although FIGS. 1A-1C show three embodiments of a working tool 10, it should be understood by one having ordinary skill in the art that any working tool used in lawn maintenance or property maintenance are encompassed by the scope of the term “working tool.”

The working tool 10 includes a power source 12, which may be formed as an internal combustion engine, an electric motor, a hybrid power source, or the like. The power source 12 illustrated in FIGS. 1A-1C are all internal combustion engines. The power source 12 is operatively connected to a frame 14. It should be understood by one having ordinary skill in the art that the frame 14 may be formed as a structural frame formed of rails or platforms, or in for a walk-behind mower, the frame 14 is formed as a mowing deck. The frame 14 is generally a rigid and stable structure formed of one or more rigidly-connected members to which various components of the working tool 10 are attached.

Each illustrated embodiment of the working tool 10 includes at least a pair of opposing wheel assemblies 16 operatively connected to the frame 14, as shown in FIGS. 1A-1C. The working tool 10 also includes a handle 18 extending from the frame 14, wherein the handle 18 allows the operator to control the direction of the working tool 10. In the illustrated embodiments, the handle 18 is directly attached or coupled to the frame 14, but it should be understood by one having ordinary skill in the art that the handle 18 may also be indirectly or operatively connected to the frame 14 in a manner in which at least a portion of the vibration of the frame 14 is transferred to the user-graspable handle 18.

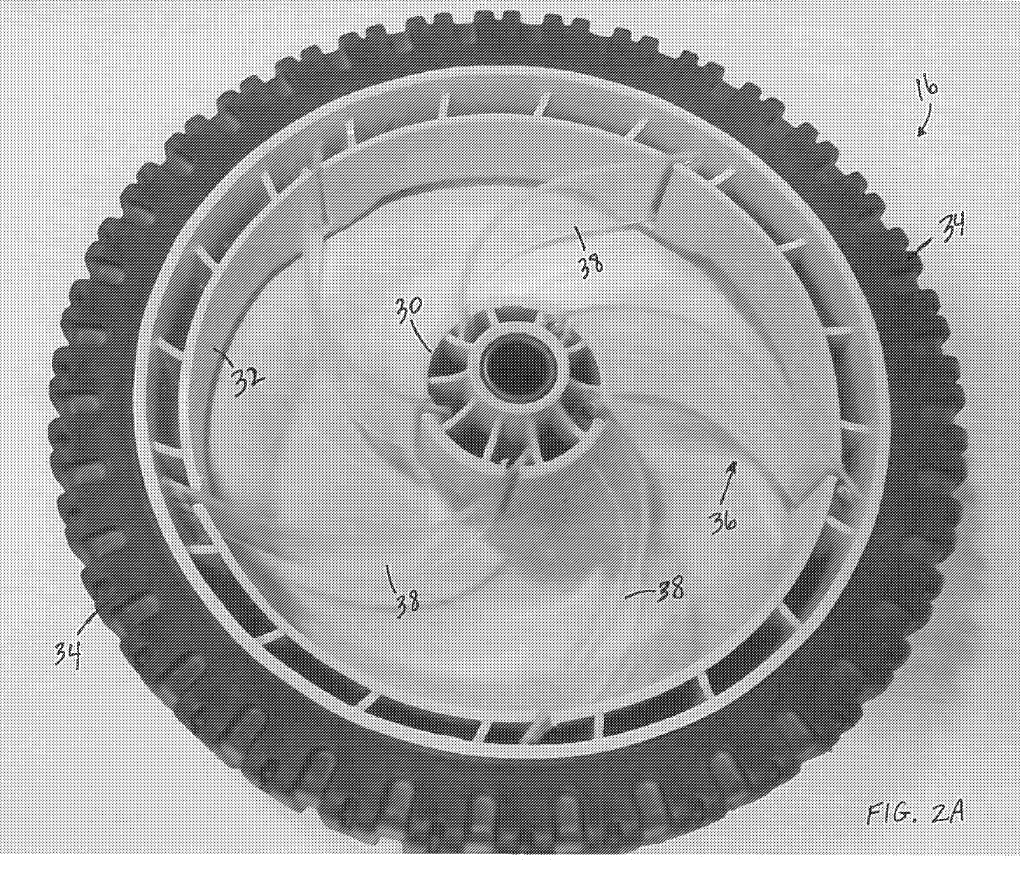

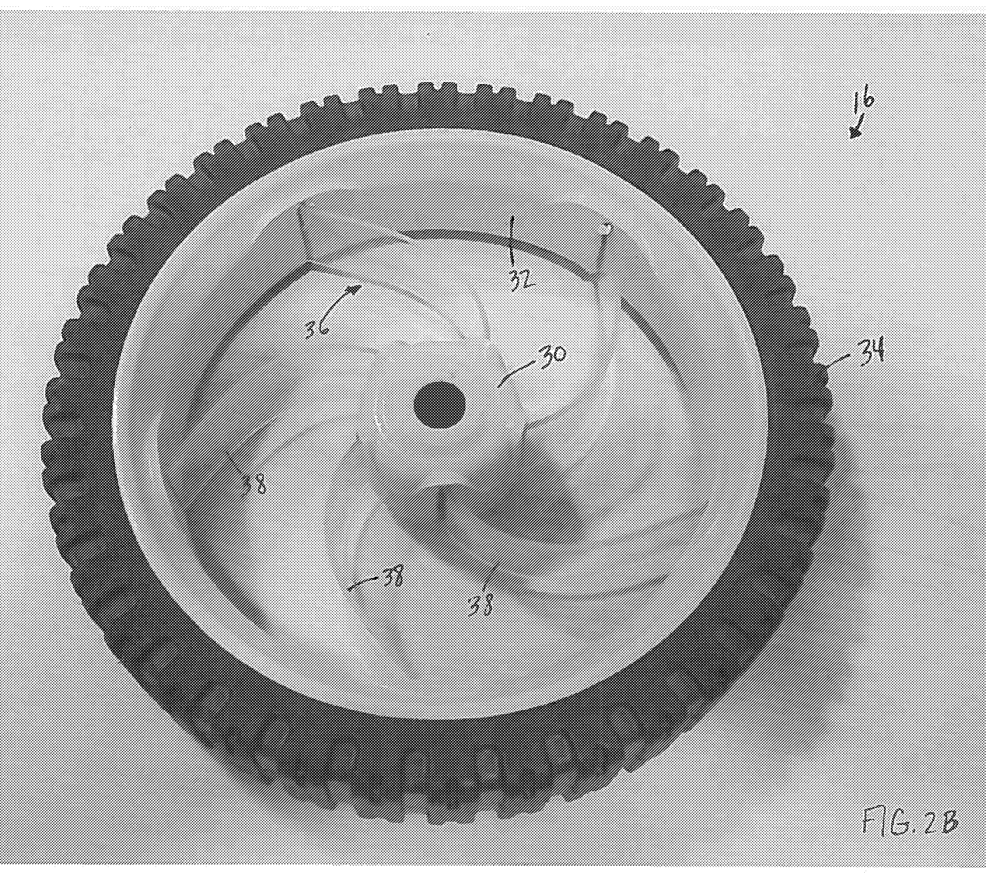

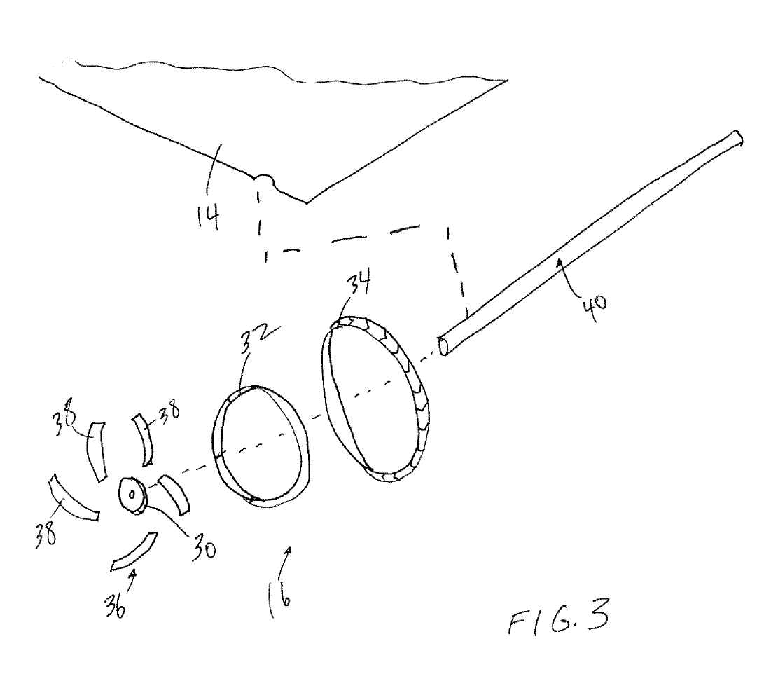

In the illustrated embodiment, each wheel assembly 16 includes a hub 30, a rim 32, a tire 34, and a vibration dampening assembly 36 that extends between the hub 30 and the rim 32, as shown in FIGS. 2A-2B and 3. The hub 30 includes an aperture formed at least partially therethrough for receiving an axle 40, and the wheel assembly 16 rotates about the longitudinal axis of the axle 40. The axle 40 is operatively connected to the frame 14, wherein the axle 40 is configured to rotate relative to the frame 14. The tire 34 is a rubber tire that is attachable to the rim 32. The tire 34 can be a solid one-piece member or the tire 34 may form an annular passageway that is configured to receive an inflatable tube. The rim 32 is a solid, generally rigid member that receives the tire 34, wherein the tire 24 is releasably attachable to the outer circumferential surface of the rim 32. The vibration dampening assembly 36 extends between the rim 32 and the hub 30 to provide vibration dampening or suspension between the rim 32 and hub 30. In other embodiments, the vibration dampening assembly 36 extends between the hub 30 and the tire 34 without the need for a rim 32. In still other embodiments, the vibration dampening assembly 36 extends between the hub 30 and the axle 40.

In an embodiment, the vibration dampening assembly 36 is formed as a plurality of elastic elements 38 that are configured to flex, bend, or otherwise deflect, thereby providing a vibration absorbing medium between the rim 32 and hub 30. The dampening assembly 36 is flexible and is configured to absorb vibration being transferred between the rim 32 and the hub 30. In the embodiments shown in FIGS. 2A-2B and 3, the elastic elements 38 are formed as curved plastic members that extend outwardly from the hub 30 to the rim 32. The elastic elements 38 have a substantially constant thickness, and the curved shape of each elastic element 38 is substantially the same for each elastic element 38 so as to provide a substantially consistent spring constant. The illustrated embodiment of the vibration dampening assembly 36 includes five (5) elastic elements 38, but it should be understood by one having ordinary skill in the art that any number of elastic elements 38 can be used to provide a pre-determined spring constant between the hub 30 and the rim 32. The illustrated elastic elements 38 are formed as a single member, but it should be understood by one having ordinary skill in the art that the elastic elements can also be formed of multiple members attached together or operatively connected to each other.

In other embodiments, each elastic element 38 can be formed as a multiple-piece substantially linear member that is configured to extend between the hub 30 and the rim 32. These linear members may include a spring or a spring-like member positioned between the hub 30 and rim 32. In other embodiments, the spring is operatively connected to posts at opposing distal ends of the spring, and the posts extend radially to connect to the hub 30 and rim 32. It should be understood by one having ordinary skill in the art that each of the elastic elements 38 can be formed of any number of components and extend linearly or otherwise between the hub 30 and the rim 32 to provide suspension, or vibration dampening, between the hub 30 and the rim 32. The elastic elements 38 of the dampening assembly 36 can all be formed of the same material(s) to provide the same dampening characteristics. In other embodiments, some of the elastic elements 38 of the dampening assembly 36 can be configured to provide vibration dampening between the hub 30 and the rim 32 while other elastic elements 38 of the dampening assembly 36 can be configured to provide rotational stability between the hub and the rim 32.

The spring constant of the vibration dampening assembly 36 is primarily dependent upon: (1) the material of the elastic elements 38, (2) the thickness of the elastic elements 38, and (3) the shape of the elastic elements 38. As such, the curvature of the elastic elements 38 can be adjusted such that the elastic elements 38 have a larger or smaller curvature. It should be understood by one having ordinary skill in the art that although the illustrated embodiment is generally C-shaped, other embodiments of the elastic elements may have other shapes, such as S-shaped, D-shaped, or the like. In even further embodiments, the elastic elements 38 can be formed as other elastic or deformable elements such as compression springs, struts, or other vibration absorbing components. The thickness may vary from elastic element 38 to elastic element 38, and/or the thickness may vary along the length of the elastic element 38. The elastic elements 38 may be formed of the same material, or the elastic elements 38 may be formed of multiple materials coupled to each other to form each elastic element 38.

As shown in FIG. 2A, a distal end of each elastic element 38 is inserted through a slot formed through the inner wall of the rim 32 such that the end of the elastic element 38 is positioned within the rim 32 in a non-attached manner, wherein the end of the elastic element 38 includes at least one knob that prevents the distal end of the elastic element 38 from disengaging from the rim 32. In a similar manner, the opposing distal end of each elastic element 38 is inserted through a slot formed through the inner wall of the hub 30 such that the end of the elastic element 38 is positioned within the hub 30 in a non-attached manner. This manner of operatively connecting the elastic elements 38 to the hub 30 and rim 32 allows the elastic elements 38 to be removed and/or replaced for repair or to optimize the vibration dampening of the elastic elements 38. In an embodiment, the elastic elements 38 are releasably attachable to the rim 32 and the hub 30.

The vibration dampening assembly 36 is configured to reduce the amount of vibration that is transmitted to the handle 18 from the frame 14 as the working tool 10 traverses rough or uneven terrain, thereby providing a suspension system for the wheel assembly 16. As a result, the vibration dampening assembly 36 is configured to reduce the vibration felt by an operator as they grasp the handle 18 and guide the working tool 10. The vibration dampening assembly 36 does not necessarily eliminate all movement of the frame 14 or eliminate all vibration that is transferred to the handle 18, but the spring constant of the elastic elements 38 can be adjusted or otherwise optimized so as to smooth out the peak effects of the movement of the frame 14 that results from the wheel assemblies 16 traversing the rough or uneven ground. The smoothed-out effect of the vibration dampening assembly 36 provides a more comfortable working experience for the operator and reduces fatigue in the operator's arms during extended use of the working tool 10.

In other embodiments (not shown), the vibration dampening assembly 36 is located between the tire 34/rim 32 and the frame 14 of the working tool 10. In the illustrated embodiment, the vibration dampening assembly 36 is located between the rim 32 and the hub 30 of the wheel assembly 16, but it should be understood by one having ordinary skill in the art that the vibration dampening assembly 36 can also be located between the hub 30 and the axle 40, between the axle 40 and the frame 14, or between the tire 34 and the axle 40. The vibration dampening assembly 36 is also configured to minimize the unsprung weight, which allows the mass of the working tool 10 to equalize or smooth out the overall movement of the frame 14 which is transferred to the handle 18. If the vibration dampening assembly 36 provides too much suspension or dampening, this additional suspension or dampening may result in excessive movement of the frame 14 that compensates for the vibration absorption of the elastic elements 38. This excess movement on walk-behind lawn mowers would result in an uneven cut as the mower deck moves.

In operation, when the wheel assembly 16 traverses a bump or depression in the terrain, the dampening assembly 36 flexes or otherwise allows the hub 30 to move toward the rim 32. The dampening assembly 36 reacts by absorbing a portion of the energy transfer between the rim 32 and the hub 30 such that the central axis of the hub 30 does not travel the same distance as the central axis of the rim 32 in response to traversing the bump or depression. Whereas, if there is a solid, non-flexible connection between the hub 30 and rim 32, the central axis of both components would travel the same distance in response to traversing the bump or depression such that the movement of the wheel assembly 16 in response to traversing the bump or depression would be directly translated to substantially equal movement of the frame 14. The flexure of the elastic elements 138 of the dampening assembly 136 allows the resulting movement of the frame 14 to be lessened because the distance of travel of the central axis of the hub 30 is less than the distance of travel of the central axis of the rim 32.

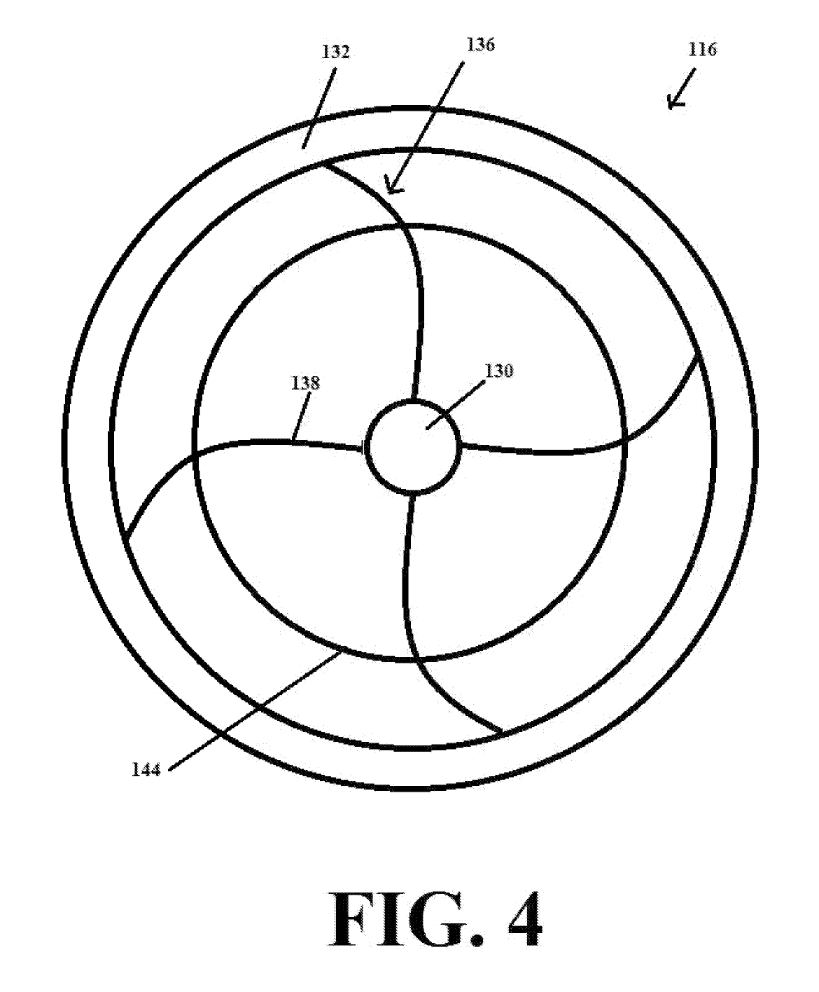

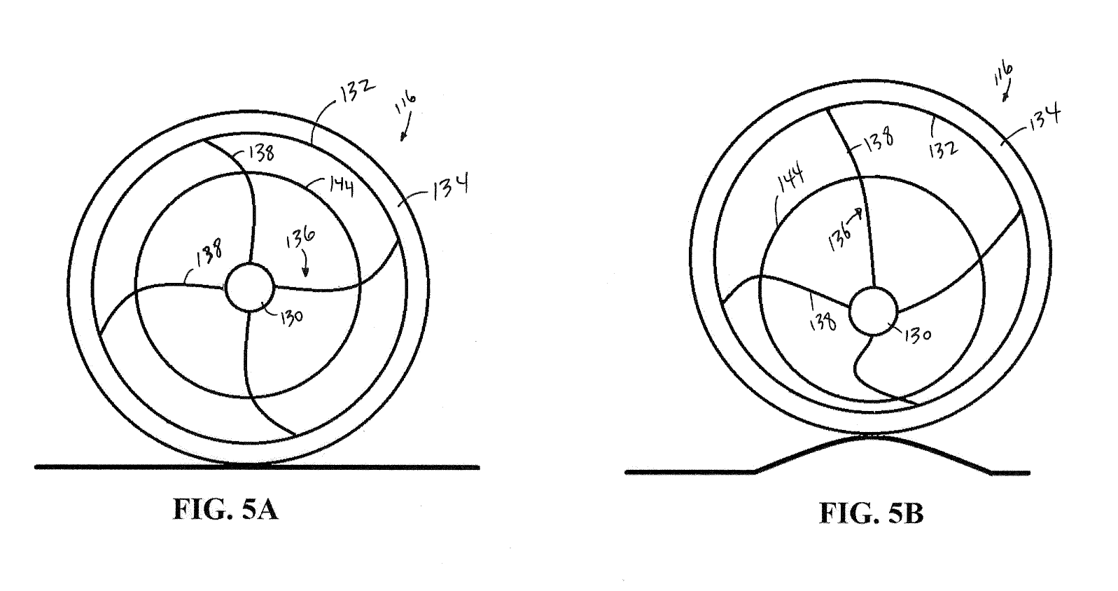

FIG. 4 illustrated another embodiment of a wheel assembly 116. The illustrated wheel assembly 116 includes a hub 130, a rim 132, a dampening assembly 136 extending between the hub 130 and the rim 132, and a limiter 144 operatively connected to the dampening assembly 136. The hub 130 is configured to receive an axle 40, which allows the wheel assembly 116 to be attachable to the frame 14 of a working tool 10. The rim 132 is positioned in a concentric orientation, surrounding the hub 130. The dampening assembly 136 extends between the hub 130 and the rim 132 to provide a suspension, or vibration dampening, to the working tool 10 as it passes over rough terrain. In the illustrated embodiment, the dampening assembly 136 is formed as a plurality of generally C-shaped elastic elements 138 that are each operatively connected to both the hub 130 and the rim 132. In an embodiment, both opposing ends of each elastic element 138 is fixedly attached to the hub 130 and the rim 132. In other embodiments, the opposing ends of at least one of the elastic elements 138 is operatively connected to the hub 310 and the rim, thereby allowing the elastic element 138 to be removed and replaced. The limiter 144 is a generally cylindrical member that is oriented concentrically with the hub 130 and the rim 132, as shown in FIG. 4. The limiter 144 is positioned between the hub 130 and the rim 132, and the limiter 144 is operatively connected to the dampening assembly 136. In an embodiment, the limiter 144 is fixedly attached to each of the elastic elements 138 of the dampening assembly 136. In another embodiment, the limiter 144 includes a plurality of slots (not shown), wherein each slot is configured to receive one of the elastic elements 138 such that the limiter 144 is maintained in an abutting relationship with the dampening assembly 136. As a result of the curvature and circumferential spacing of the elastic elements 138, it is not necessary that the limiter 144 be fixedly attached to the elastic elements 138 because the elastic elements 138 maintain the limiter at substantially the same relative position relative to the hub 130 and the rim 132 when the wheel assembly 116 is unstressed. The limiter 144 is configured to limit the movement of the hub 130 relative to the rim 132. As the wheel assembly 116 traverses a bump or depression and the rim 132 begins to move toward the hub 130, the dampening assembly 136 is reducing the amount of relative travel of the hub 130. However, in order to prevent the hub 130 from contacting the rim 132 during extreme conditions—which may cause the elastic elements 138 to break—the limiter 144 contacts the rim 132 to prevent the rim 132 from further movement toward the hub 130 as shown in FIGS. 5A-5B. The limiter 144 helps to maintain the integrity of the elastic elements 138 of the dampening assembly 136.

While preferred embodiments of the present invention have been described, it should be understood that the present invention is not so limited and modifications may be made without departing from the present invention. The scope of the present invention is defined by the appended claims, and all devices, processes, and methods that come within the meaning of the claims, either literally or by equivalence, are intended to be embraced therein.

What is claimed is:

1. A walk-behind working tool comprising:
a frame;
a power supply attached to said frame;
a handle extending from said frame; and
an axle operatively connected to said frame, wherein said axle is rotatable relative to said frame; and
at least one wheel assembly operatively connected adjacent to each end of said axle, wherein each wheel assembly comprises:
a hub attachable to said axle;
a rim; and
a dampening assembly extending between said rim and said hub for absorbing vibration being transferred between said rim and said hub.

2. The walk-behind working tool of claim 1, wherein said dampening assembly includes a plurality of elastic elements extending between said rim and said hub.

3. The walk-behind working tool of claim 2, wherein each of the elastic elements is formed as a plastic C-shaped member.

4. The walk-behind working tool of claim 2, wherein said elastic elements are operatively connected to said hub and said rim in a non-attached manner.

5. A wheel assembly for a working tool comprising:
a hub attachable to an axle;
a rim surrounding said hub in a concentric manner; and
a flexible dampening assembly extending between said rim and said hub.

6. The wheel assembly of claim 5, wherein said dampening assembly includes a plurality of elastic members extending between said hub and said rim.

7. The wheel assembly of claim 6, wherein said elastic members are releasably connected to said hub and said rim.

8. The wheel assembly of claim 5, wherein said elastic members are generally C-shaped.

9. The wheel assembly of claim 5 further comprising a tire removably attachable to said rim.

10. The wheel assembly of claim 6 further comprising a limiter operatively connected to said dampening assembly and positioned between said rim and said hub to prevent contact between said rim and said hub.
